(19) United States
(12) Patent Application Publication
(10) Pub. No.: US 2026/0115083 A1
(43) Pub. Date: Apr. 30, 2026

(54) FINGER EXOSKELETON, FINGER ORTHOSIS AND METHOD OF MANUFACTURING A FINGER ORTHOSIS

(71) Applicant: Georg-August-Universität Göttingen Stiftung Öffentlichen Rechts, Universitätsmedizin, Göttingen (DE)

(72) Inventor: Miguel Angel Bravo Cabrera, Göttingen (DE)

(73) Assignee: Georg-August-Universität Göttingen Stiftung Öffentlichen Rechts, Universitätsmedizin, Göttingen (DE)

(21) Appl. No.: 19/362,646

(22) Filed: Oct. 20, 2025

Related U.S. Application Data
(63) Continuation of application No. PCT/EP2024/059707, filed on Apr. 10, 2024.

(30) Foreign Application Priority Data
Apr. 20, 2023 (DE) 10 2023 110 094.7

(51) Int. Cl. A61H 1/02; B33Y 50/00; B33Y 80/00

(52) U.S. Cl. CPC A61H 1/0288; B33Y 50/00; B33Y 80/00; A61H 2201/1215; A61H 2201/14; A61H 2201/1454; A61H 2201/1635; A61H 2201/1676

(57) ABSTRACT

The invention relates to a finger orthosis for a finger exoskeleton. The finger orthosis comprises an actuating member, a second phalanx accommodation and a third phalanx accommodation. The second phalanx accommodation is freely pivotable in a first joint on the actuating member. The second phalanx accommodation is coupled to the third phalanx accommodation via a constraining guide in such a way that a fixed dependency of the relative first pivot angle between the actuating member and the second phalanx accommodation on the one hand and the relative second pivot angle between the second phalanx accommodation and the third phalanx accommodation on the other hand is given. The finger orthosis according to the invention is easy to dimension and can be specifically adapted to a patient. The invention also relates to a finger exoskeleton and a method of manufacturing a finger orthosis.

### CROSS REFERENCE TO RELATED APPLICATIONS

This application is a continuation to international application PCT/EP2024/059707 entitled “Finger-Exoskelett, Fingerorthese und Verfahren zur Herstellung einer Fingerorthese” filed Apr. 10, 2024 and claiming priority to German patent application DE 10 2023 110 094.7 also entitled “Finger-Exoskelett, Fingerorthese und Verfahren zur Herstellung einer Fingerorthese” and filed on Apr. 20, 2023, the disclosures of which are hereby incorporated herein by reference in their entirety.

### FIELD OF THE INVENTION

The mobility of at least one finger of a hand can be restricted, for example, by a finger or hand injury and/or a degenerative muscle disease. The invention relates to a finger orthosis which can ensure movement and/or guidance of the phalanges of a finger. Furthermore, the invention relates to a finger exoskeleton in which the movement of the finger orthosis and of the phalanges of a finger guided by the finger orthosis can be brought about by means of an actuator. Finally, the invention relates to a method of manufacturing a finger orthosis.

### BACKGROUND OF THE INVENTION

WO 2016/077 872 A1 discloses a finger exoskeleton with a finger orthosis and an actuator for actuating the finger orthosis. An end region of the actuator is held on a proximal end region of a hand plate. At a distal end region of the hand plate, a cranked upper actuating member and a cranked lower actuating member are each pivotably mounted on the hand plate in close proximity to one another in a joint. A plunger moved by the actuator is hinged to the crank of the upper actuating member. A first phalanx support, a second phalanx support and a third phalanx support are each embodied as a half-shell and are intended for one-sided contact with an associated phalanx from above. The distal end region of the first phalanx support is pivotably connected to the proximal end region of the second phalanx support via a joint. Correspondingly, the distal end region of the second phalanx support is connected to the proximal end region of the third phalanx support via a joint. The lower actuating member is rigidly connected to the first phalanx support. The joint connecting the hand plate to the lower actuating member is spaced apart from the MCP joint. In contrast, the upper actuating member is connected to a protrusion of the second phalanx support via a joint. The articulation or attachment of the two actuating members to different phalanx supports and the articulation of the phalanx supports to each other leads to the result that the movement of the actuating members as a result of actuating the actuator not only causes a movement of the second phalanx support, but also leads to a coupled pivoting of the first phalanx support. At a distance both from the joint which connects the first phalanx support to the second phalanx support and from the joint by which the upper actuating member is connected to the protrusion of the second phalanx support, an end region of a cranked coupling rod is articulated to the upper actuating member via a further joint. The other end region of the coupling rod is connected to a joint of the third phalanx support. As a result of this coupling, the actuation of the actuator also leads to a coupled pivoting of the third phalanx support. The hand plate intended for contacting the back of the hand comprises a first hand plate part and a second hand plate part. The actuator is linked to the first hand plate part, while the two actuating members are linked to the second hand plate part. The two hand plate parts are movable relative to each other to enable a required compensating movement. WO 2016/077 872 A1 proposes manufacturing the parts of the finger orthosis on the basis of a 3D model using a 3D printing technique. For this purpose, a 3D hand model of the hand is first created by scanning the hand using a 3D scanner. The lengths of the phalanges are determined from the 3D hand model and taken into account (in a manner not described in detail) in the 3D model of the finger orthosis.

WO 2017/127 887 A9, corresponding to U.S. Pat. No. 11,331,205 B2 and U.S. Pat. No. 11,963,889 B2, describes a CRD and CRM manufacturing process in which components are manufactured from a 3D model using an additive manufacturing process. This manufacturing process is intended to be used for medical devices such as surgical instruments, implants and orthoses. The process is intended to enable individual adaptation of the medical device to the respective patient.

CN 1 14 469 643 A discloses a hand exoskeleton comprising a support plate and five finger modules for the five fingers of a hand. Each finger module comprises three phalanx accommodations for the first, second and third phalanx. The finger phalanx accommodations are connected to each other and to the support plate via pivot bearings. Each finger module also comprises a push rod mechanism. The push rod mechanism is actuated by a linear actuator, which is arranged in the area of the back of the hand, and which comprises several push rods, which are connected to each other, to the linear actuator and to the phalanx accommodations via pivot bearings. The arrangement of phalanx accommodations and push rods is kinematically determined in such a way that the instantaneous poles of the phalanx accommodations are fixed in relation to the holding plate or move along a fixed predetermined path in relation to the holding plate. The phalanx accommodations of the finger modules of the hand exoskeleton therefore always perform the same fixed movements when the linear actuator is actuated. If, on the other hand, the linear actuator is not actuated, the phalanx accommodations of the finger modules are statically determined and cannot move.

CN 1 06 994 086 A discloses an exoskeleton for rehabilitation training with a mounting plate to which five finger mechanisms are attached. Each finger mechanism is actuated by a linear actuator and comprises a first and a second phalanx accommodation for a first and a second phalanx. There is no third phalanx accommodation for a third phalanx. A guide carrier is linked to the mounting plate, in whose curved guide slot the first phalanx accommodation for the first phalanx is guided. The second phalanx accommodation is guided via coupling rods relative to the accommodation for the first phalanx and relative to the mounting plate. Actuation of the linear actuator displaces the first phalanx accommodation along the curved guide slot so that the first phalanx accommodation performs a pivoting movement, whereby the accommodation for the second phalanx also performs a pivoting movement due to the coupling rods. Here, too, the movement of the phalanx accommodations is fixed.

CN 1 10 916 972 A discloses a rehabilitation device for a hand, wherein a finger mechanism with an actuator is attached to a hand mounting plate. The finger mechanism comprises a first, a second and a third phalanx accommodation for the phalanges, which are connected to each other and to coupling rods via joints. An arrangement of coupling rods ensures the required movements of the finger phalanx accommodations relative to the hand mounting plate.

The publications DE 20 2015 008 342 U1 and US 2021/0145620 A1 disclose an orthosis which is attached to a forearm and a metacarpus and serves to immobilize a wrist, comparable to a splinting of the wrist. In DE 20 2015 008 342 U1, the fingers are additionally guided by means of elastic elements.

### Definitions

In the context of the invention, a “joint” is understood to be a connection of two members which does not allow any displacement in any spatial direction in the area of the connection, but does allow the members to pivot about at least one pivot or rotational axis running through the joint. The joint can provide any number of degrees of rotation and/or pivoting movement. A pivoting degree is understood here, for example, as a degree of freedom for pivoting about a pivot axis that is oriented transversely to the longitudinal axis of one of the members and/or vertically to the pivot plane in which the members connected via the joint are pivoted relative to one another. It is possible for a joint to be embodied as a pivot bearing comprising only one pivoting degree of freedom about a single pivot axis, in which case the pivot bearing can also be designed in the manner of a “hinge”. In the context of the invention, a rotational degree of freedom of a joint can ensure a relative rotation of the members about the longitudinal axis of at least one of the members. If several degrees of freedom are described for a joint, these can be ensured by the same joint parts and contact surfaces of the joint parts. However, it is also possible that these degrees of freedom can be provided by different contact surfaces of the joint parts, which can then also be arranged at a distance from one another, so that the degrees of freedom of the joint are provided with a spatial offset to one another.

In the context of the invention, a “member” is understood to be an element of the finger orthosis which can be connected via a joint or otherwise to an adjacent component, to an adjacent member or to a plunger of an actuator. The member can comprise a constant or variable cross-section and/or extend in a straight line or any desired curved shape in the direction of its longitudinal extension. In the case of a curved course, a longitudinal axis of the member refers in particular to the connecting axis of the joints or other connections of the member. It is possible that only two joints act on a member (preferably in the two end regions), whereby the member forms a pendulum support in the sense of the mechanical nomenclature. However, it is also quite possible that at least three joints or other connections act on a member at more than two locations.

### SUMMARY OF THE INVENTION

In accordance with a solution to the object underlying the invention, a finger orthosis is proposed which is intended for use in a finger exoskeleton in which the finger orthosis can be actuated by means of an actuator, in particular an electric motor, wherein the actuator can then in particular cause the finger orthosis (and a finger arranged therein or thereon) to bend and extend.

The invention proposes a finger orthosis, a finger exoskeleton and a method of manufacturing a finger orthosis which is improved in particular with regard to the manufacturing effort and/or individualization for different patients and/or the interaction with the patient and/or automation of the manufacturing process.

The finger orthosis has an actuating member which can be coupled (directly or indirectly) to the actuator. The finger orthosis further comprises two members embodied as second phalanx accommodation and third phalanx accommodation. The second phalanx accommodation is intended for the abutment or accommodation of the second phalanx (phalanx media) of the user's hand, while the third phalanx accommodation is intended for the abutment or accommodation of the third phalanx (phalanx distalis) of the finger of the user's hand. Preferably, the finger orthosis has no first phalanx accommodation, so that the finger orthosis only applies forces and/or moments on the second phalanx and the third phalanx, but not on the first phalanx (phalanx proximalis).

In one embodiment of the finger orthosis, the second phalanx accommodation is articulated to the actuating member in a first joint. Here, the second phalanx accommodation is freely pivotable relative to the actuating member, so that this degree of freedom of movement of the second phalanx accommodation is not restricted by further members of the finger orthosis. On the other hand, in the finger orthosis the second phalanx accommodation is coupled to the third phalanx accommodation via a constraining guide. This constraining guide provides a fixed dependency between the relative first pivot angle between the actuating member and the second phalanx accommodation and the relative second pivot angle between the second phalanx accommodation and the third phalanx accommodation. The constraining guide thus has the effect that when the actuator actuates the operating member, the second phalanx is moved by the second phalanx accommodation (bending and stretching) and a desired movement of the third phalanx accommodation is also automatically brought about via the constraining guide to the extent required and predetermined by the constraining guide.

Finger orthoses known from the prior art are based on the premise that the positions of the first phalanx accommodation, the second phalanx accommodation and the third phalanx accommodation must be defined when the actuator is actuated in order to ensure exact guidance of each phalanx. However, the first phalanx, the second phalanx and the third phalanx are already connected via the metacarpophalangeal joint (MCP), the proximal interphalangeal articulation (PIP) and the distal interphalangeal articulation (DIP); DIP), which results in a kinematic overdetermination when the positions of the first phalanx accommodation, the second phalanx accommodation and the third phalanx accommodation are defined when the finger orthosis is applied to the finger. This kinematic overdetermination requires exact dimensioning of the finger orthosis, i.e. the geometries of the members, so that the joints or moment poles of the members are exactly aligned with the joints of the finger. Deviations lead to undesirable stresses on the finger or the support of the actuator on the hand, which can cause pain or delay or even worsening of the healing process, as well as skin irritation due to relative movements of the contact points of the finger orthosis in relation to the skin. The free pivoting of the second phalanx accommodation relative to the actuation member (and the possible absence of a first phalanx accommodation) is used to reduce or even eliminate the kinematic overdetermination, thereby avoiding skin irritation, undesired application of forces to the fingers and movement restrictions due to the finger orthosis and reducing the effort required to adapt the finger orthosis to the patient's fingers and hand.

For the embodiment described in the prior art document WO 2016/077 872 A1, the kinematic overdetermination arises in that the phalanx accommodations are guided not only by a single actuating member, but by an upper actuating member and a lower actuating member, which are each articulated with different joints on one hand to a hand plate and on the other hand to the second phalanx accommodation. According to one embodiment, only one single actuating member can be used, which can pass the first phalanx without interacting with the first phalanx.

Preferably, the second phalanx accommodation is connected to a hand plate and/or an associated holding device of the hand plate and possibly an actuator when the finger orthosis is used as a finger exoskeleton exclusively via a single actuating member, which extends in the area of the first phalanx without touching close to the first phalanx. Alternatively, this connection can be provided by two actuating members, which are then articulated with coaxial pivot axes on the one hand to the second phalanx accommodation and on the other hand to the hand plate or the holding device and possibly the actuator and perform a joint parallel movement.

There are many possibilities for the design of the constraining guide. For one proposal, the constraining guide is provided in that the second phalanx accommodation is connected to the third phalanx accommodation via a second joint. The second joint thus ensures relative pivoting about a pivot axis defined by the second joint. A coupling rod is also provided. The coupling rod is articulated (preferably in an end region) by means of a first coupling rod joint to the actuating member at a location spaced from the first joint. Furthermore, the coupling rod is articulated (preferably in the other end region) by means of a second coupling rod joint to the third phalanx accommodation at a location spaced from the second joint. The use of the second joint and the coupling rod with the associated coupling rod joints enables the desired constraining guide in a particularly simple manner. By shaping and dimensioning the coupling rod and selecting the locations of the first coupling rod joint and the second coupling rod joint, the type of constraining guide, i.e. the dependency between the relative first pivot angle and the relative second pivot angle, can be easily defined by design.

In one embodiment, the finger orthosis comprises a pair of members, in particular actuating members, and/or a pair of coupling rods, which are arranged on both sides of the finger in the finger orthosis and thus on both sides of the phalanx accommodations and which can comprise aligned pivot axes, whereby the forces to be absorbed can then be distributed over these pairs of members or coupling rods and symmetrical loading takes place. In one proposal, the finger orthosis is equipped with only one single actuating member. This single actuating member can then extend only on one side of the finger or the phalanx accommodations, although it is also quite possible that this single actuating member extends helically around the finger or the phalanx accommodations with a winding angle which is preferably in the range from 50° to 120° or 70° to 100°. Alternatively or cumulatively, it is possible that the second phalanx accommodation and the third phalanx accommodation are connected to each other exclusively via the second joint and one single coupling rod. In extreme cases, the finger orthosis can have only four members, namely the actuating member, the second phalanx accommodation, the third phalanx accommodation and the coupling rod as well as the associated joints, which ensures a particularly simple design of the finger orthosis while reducing the number of components required and thus the stocking effort, the assembly effort and the manufacturing effort. This finger orthosis with only four members can then be biased (directly or indirectly) by a plunger of an actuator and thus be bent and extended. If the finger orthosis is not equipped with a first phalanx accommodation so that the finger orthosis does not come into contact with the first phalanx at all, this can lead to increased wearing comfort and also to the reduced kinematic restrictions explained at the beginning. If there is only one single actuating rod and one single coupling rod, these can be arranged on the same side of the finger or on different sides of the finger,

The phalanx accommodations can be embodied as desired, as long as they are supported at least in one direction on the associated phalanx by means of a contact surface. For a particular proposal, the second phalanx accommodation and/or the third phalanx accommodation comprises a recess or through recess. This (through) recess comprises an edge-closed cross-section. The associated phalanx can extend through the (through) recess and thus through the phalanx accommodation. The (through) recess can be surrounded in one piece by the second phalanx accommodation over the entire circumference. However, it is also possible for the second phalanx accommodation to surround the (through) recess with several components that can be opened and closed, for example, or with a half-shell-shaped base body which is closed in the circumferential direction by means of a strap, in particular an elastic strap or a Velcro strap. The (through) recess can be dimensioned according to the geometry and cross-section of the associated phalanx, whereby the (through) recess can accommodate the phalanx without play or with play. The (through) recess can ensure any number of degrees of freedom relative to the phalanx. Preferably, however, the (through) recess is designed in such a way that the phalanx can slide into the (through) recess when the finger orthosis is put on, while the phalanx is then arranged in the (through) recess without play. If the (through) recess has a sufficient longitudinal extension, the through recess can also define the orientation of the longitudinal axis of the phalanx relative to the orientation of the phalanx accommodation.

In the present context, the third phalanx accommodation can comprise a through recess from which the fingertip can protrude, or the third phalanx accommodation can be embodied as a cap with a recess into which the third phalanx can be inserted.

As explained, the actuating member is articulated (preferably in one end region) to the second phalanx accommodation and/or the coupling rod. The first end region can be articulated exclusively to the actuator or a plunger of the actuator. Preferably, the actuating member (possibly in addition to being linked to the actuator or a plunger of the actuator) is pivotably held on a holding device via an actuation joint. Preferably, the actuation joint has only one single pivot axis. The holding device can provide support (for example via a hand plate) on the hand, in particular the back of the hand. It should be noted that the pivot axis of the actuation joint should not coincide with the pivot axis of the MCP joint of the finger, but that these pivot axes are arranged at a defined distance from one another, with the pivot axis of the actuation joint of the finger orthosis preferably being arranged above the pivot axis of the MCP joint of the finger, i.e. above the back of the hand or dorsal to the back of the hand. In the present context, the actuation joint is preferably
a connecting joint between the orthosis and the actuator and/or
arranged in the distal end region of the back of the hand and/or
arranged above the back of the hand and/or
arranged closely adjacent to and/or above the MCP body joint of the finger and/or
directly connected to a plunger of the actuator, wherein in particular an end region of the plunger itself forms a joint part of the actuation joint

For one proposal, the actuation joint is arranged approximately in a vertical plane extending through the (longitudinal axes of the) (through) recesses of the phalanx accommodations. This vertical plane is oriented vertically to the flattened horizontal hand. Here, “approximately” means an arrangement in the vertical plane or at an angle of +/−20°, +/−10° or +/−5° relative to this vertical plane. For this embodiment, the first joint by which the actuating member is articulated to the second phalanx accommodation and/or the first coupling rod joint can be arranged laterally from the through recess of the second phalanx accommodation. The actuation joint is thus located above the finger arranged in the finger orthosis, while the first joint and/or the first coupling rod joint are arranged laterally thereof. This means that the actuating member winds around the finger with a winding angle in the range from 50° to 120°, preferably 70° to 100°, between the actuation joint and the first joint and/or the first coupling rod joint.

In one embodiment of the finger orthosis, the finger orthosis comprises a hand accommodation. Preferably, the hand accommodation completely surrounds the metacarpal in the circumferential direction so that the finger orthosis is attached to the metacarpal. Optionally, the hand accommodation can also be held on the hand in the area of the carpal bones and/or the wrist. The hand accommodation holds the holding device on which the actuation joint is held.

In one embodiment, the hand accommodation comprises a hand plate which, for example, enables large-area contact with the back of the hand. The hand plate can be adapted to the contour, curvature, length and/or width of the back of the hand. The hand plate can be secured to the metacarpal with at least one strap. It is also possible that, alternatively or cumulatively, the hand accommodation or hand plate is secured in the area of the wrist or the carpal bones. The hand accommodation can also be embodied as a type of glove (being open in the area of the fingers).

It is possible that the actuation joint is held directly on the hand plate or the hand accommodation. Preferably, however, a holding device is held on the hand plate or the hand accommodation. The holding device is then coupled to the actuating member via the actuation joint.

The holding device can be held on the hand plate or on the hand accommodation in any desired manner. Preferably, the holding device comprises a compensating device, which can be provided in the area of the connection of the holding device to the hand accommodation or hand plate and/or in the area of the connection of the holding device to the actuating member. The compensating device provides a length compensation, i.e. a compensating movement in the direction of the longitudinal axis of the outstretched finger. Alternatively or cumulatively, the compensating device can provide a transverse compensation, i.e. a compensating movement in a direction transverse to the outstretched finger parallel to the palm plane. Alternatively or cumulatively, a height compensation, i.e. a compensating movement vertical to the palm plane, can be provided. Alternatively or cumulatively, an angle compensation is provided, for example a change in the angle relative to the longitudinal axis of the outstretched finger. In this case, the compensating device can also provide a longitudinal degree of freedom, transverse degree of freedom, vertical degree of freedom or angular degree of freedom during operation of the finger orthosis. However, it is also possible that the compensation is only used for adjustment in the longitudinal direction, in the transverse direction, in the vertical direction or of the angle, while at least one of the degrees of freedom is fixed after an initial adjustment.

Preferably, the holding device is connected to the hand plate via a pivot bearing. The pivot bearing allows the holding device to change angle about a vertical axis, which is an axis vertical to the palm plane. The degree of freedom provided by the pivot bearing can be used to adjust the finger orthosis if the hand plate and the members of the finger orthosis are not exactly aligned with each other or if bending and extending the fingers is associated with a lateral movement of the finger (adduction and abduction), which can then be compensated for by means of the pivot bearing.

In a further embodiment of the finger orthosis, the hand accommodation comprises a further hand plate in addition to the said hand plate, wherein the two hand plates may have the same or different sizes, stiffnesses, thicknesses and materials. The first-mentioned hand plate is intended for contact with the back of the hand and carries the holding device, while the other hand plate is intended for contact with the palm of the hand. In this case, the hand plate and the other hand plate can be connected to each other via straps, in particular adjusting or tensioning straps, which then extend laterally around the hand. The hand plates and the straps thus form a through recess through which the hand can extend in the area of the metacarpal bones. In this way, a good support of the finger orthosis on the hand can be provided, with the two hand plates ensuring that forces are distributed over a large area of the hand.

Preferably, the hand plate on which the actuator and the actuation joint are held is embodied as one single piece. This embodiment is based on the realization that a two-part hand plate, as known from WO 2016/077 872 A1, can lead to undesirable relative movements of the hand plate parts, which can lead to additional undesirable stresses on the hand and/or worsen the guidance of the members of the finger orthosis. Some above described embodiments of the finger orthosis make it possible to use a one-piece hand plate.

A further aspect is devoted to the dimensioning of the finger orthosis. Here, the dimensioning uses two scaling factors. A first scaling factor is a proximal scaling factor PSKF, which can be determined on the basis of an actual size of the first phalanx of a patient to whose anatomy the finger orthosis is to be individually adapted, relative to a standard size of the first phalanx. A second scaling factor is a distal scaling factor DSKF, which can take into account the ratio of the specific length of the patient's second phalanx to a standard length of the second phalanx. Standard coordinates and standard distances are also used for the dimensioning. Here, a first standard coordinate x_{N,24}, y_{N,24} is the coordinate of the actuation joint relative to the MCP body joint of the patient's finger. A first standard distance A_{N,24-18} is the distance of the actuation joint from the first joint. Optionally, a second standard distance A_{N,56-18} can describe the distance of a finger middle joint arranged in the finger orthosis from the first joint. Second standard coordinates x_{N,21}, y_{N,21} describe the coordinates of the first coupling rod joint. A third standard distance A_{N,19-22} describes the standard distance of the second joint from the second coupling rod joint. Finally, a fourth standard distance A_{N,21-22} describes the standard distance of the first coupling rod joint from the second coupling rod joint. The standard coordinates and standard distances can given and stored.

According to one embodiment, dimensioning then takes place in such a way that
a) by means of the proximal scaling factor PSKF
   the first standard coordinates x_{N,24}, y_{N,24} are converted into the actual coordinates of the actuation joint x_{P,24}, y_{P,24} and
   the actual distance A_{P,24-18} between the actuation joint and the first joint is calculated from the first standard distance A_{N,24-18}, and
b) by use of the distal scaling factor DSKF
   the actual coordinates (x_{P,21}, y_{P,21}) of the first coupling rod joint are calculated from the second standard coordinates (x_{N,21}, y_{N,21}),
   the actual distance A_{P,19-22} of the second joint from the second coupling rod joint is calculated from the third standard distance A_{(N,19-22)} and
   the actual distance A_{P,21-22} of the first coupling rod joint from the second coupling rod joint is calculated is calculated from the fourth standard distance A_{N,21-22}
   wherein preferably additionally the actual distance A_{P,56-18} of a finger middle joint arranged in the finger orthosis from the first joint can also be calculated from the second standard distance A_{N,56-18} by use of the proximal scaling factor PSKF.

If the standard coordinates and standard distances are known and stored in a memory unit, for example, the proximal scaling factor PSKF and the distal scaling factor DSKF can be determined for a patient from measurements, from recorded images and/or using 3D scanning technology on the basis of a 3D scan. The above dimensioning rule can then be used to dimension the finger orthosis in a simple manner, which can be used to provide a finger orthosis that can be scaled specifically for the respective patient. It is possible that further dimensioning, for example the size of a phalanx accommodation or the cross-section of a recess of the same, can be carried out according to the actual conditions of the patient. It is also possible for the actual distances and coordinates to deviate by +/−20%, +/−10% or +/−5% from the distances and coordinates determined using the above dimensioning rule. The deviations can be made, for example, to take account of deviations of a specific anatomy from an average anatomy or to bring about different kinematics or movement ranges of the finger orthosis.

It is also possible that a design or scaling of the finger orthosis takes into account preferences, specific requirements and/or a condition of the patient. For example, it is possible that areas of the hand, finger or skin with which contact is to be avoided (e.g. a suture after a surgical procedure) are specifically omitted, that the patient's preferences as to how they wish to wear the orthosis are taken into account or that functional requirements based on standardized healthcare specifications, protocols or regulations are taken into account.

In a finger orthosis, the degrees of freedom of movement and/or forces can be limited by stops for the degrees of freedom and/or by a corresponding control of the actuator that limits the travel. In the case that there is an error in the control of the actuator, this may lead to the finger being overstressed by the finger orthosis. If, for example, an electric stepper motor is used as the actuator and the control of the stepper motor loses its zero position, the range of movement of the actuator and thus the range of movement of the finger orthosis changes. On the other hand, during continuous operation of the finger orthosis, the range of movement of a finger may be restricted, so that the original adjustment range of the actuator may result in undesirable and excessive movement and stress. In one embodiment of the finger orthosis, a mechanical overload protection device is provided in a finger orthosis (which is preferably a finger orthosis as previously explained). When an overload is reached, the mechanical overload protection disconnects a mechanical connection or a member of the finger orthosis, which provides an additional degree of freedom and/or removes a (forced) coupling and the overload can be avoided.

The overload protection (with the features and embodiments described in the present application) can be used for the embodiments of the finger orthoses or finger exoskeleton described here. However, this overload protection can also be used for any other type of finger orthosis, a different orthosis, a finger exoskeleton or any other exoskeleton.

It is possible, for example, that a member of the finger orthosis or a joint is equipped with a predetermined breaking point that fails when the overload is reached. It is also possible that two longitudinal sections of a member are detachably connected to each other (e.g. by means of a magnetic connection or a snap-in or latching connection) and that this connection is released when the overload is reached.

According to one proposal, the overload protection is integrated into a joint. In this case, the joint may comprise a joint body which is rotatably captured between two joint body accommodations. In this case, the overload protection can be provided by the fact that, as a result of an overload, an elastic or plastic deformation of the joint body accommodations themselves and/or of a connecting area of the joint body accommodations and/or of the joint body occurs in such a way that the joint body can exit the joint body accommodations. If only an elastic deformation occurs for this purpose, the joint body can be reinserted into the joint body accommodations after the overload has occurred and the joint body has been released from the joint body accommodations which can be induced by applying appropriate assembly forces, so that the finger orthosis can be reused.

In this case, the joint body is preferably embodied as a partially spherical joint head. The joint body accommodations can then be embodied as joint sockets, between which the joint head is captured and supported. To give merely one non-limiting example, the joint head may be embodied by a plunger of the actuator, while the joint sockets may be embodied as an end portion of the actuating member.

A proposal is a finger orthosis for a finger exoskeleton, which can in principle be embodied as described in the previous features or in a different way. For this solution, the finger orthosis comprises an actuation joint which provides an abduction degree of freedom and an adduction degree of freedom about a pivot axis. It is possible that the actuation joint only provides this degree of freedom. Preferably, however, the actuation joint provides at least one further degree of freedom, in particular a degree of freedom for flexion and extension. Conventional finger orthoses only have joints comprising parallel degrees of freedom in order to enable the flexion and extension movement of, for example, an actuating member and a phalanx accommodation as well as any coupling rods. This embodiment is in particular based on the realization that the provision of an abduction degree of freedom and an adduction degree of freedom in an actuation joint can, on the one hand, reduce the effort required for dimensioning the finger orthosis and/or the effort required for correctly fitting the finger orthosis and for aligning the finger orthosis with the actuator and/or the finger. Under certain circumstances, the abduction degree of freedom and an adduction degree of freedom may also reduce the requirements for manufacturing accuracy of the finger orthosis. In addition, this degree of freedom of the actuation joint also allows an abduction and adduction movement to occur when flexing and extending the finger.

The design with the provision of an abduction degree of freedom and an adduction degree of freedom (with the features and embodiments described in the present application) can be used for the embodiments of the finger orthoses or finger exoskeleton described here. However, it is also possible that this design with the provision of an abduction degree of freedom and an adduction degree of freedom can also be used for any other type of finger orthosis, a different orthosis, a finger exoskeleton or any other exoskeleton.

For a particular embodiment, the actuation joint is embodied as a ball joint, wherein such a ball joint can provide the abduction and adduction degree of freedom, a degree of freedom for flexion and extension, and also a further degree of freedom, for example for rotation about a longitudinal axis of an actuating member. For an alternative or cumulative proposal, the previously explained overload protection is integrated into the actuation joint, although this can also be integrated into the ball joint.

It is possible that the actuator and the actuation joint are held on a hand plate by any fastening means such as screws, whereby the screws can be screwed with different bores to enable different settings or can be screwed with elongated holes. For one proposal, the actuation joint and/or the holding device for an actuator are/is held on the hand plate via an adjusting device. In this case, the adjusting device can enable sensitive adjustment in order to enable precise adaptation of the finger orthosis to the patient's hand.

There are many possibilities for designing the adjusting device. In one proposal, the adjusting device comprises a spindle drive. A tool can then be used to turn a spindle of the spindle drive sensitively, causing the movement of a spindle nut, which can then be connected (directly or indirectly) to the actuation joint and/or the holding device for the actuator in order to transmit the movement.

A further proposal is provided by a finger exoskeleton which has a finger orthosis, as described above, and an actuator which is coupled to the finger orthosis for actuating the finger orthosis. In this case, the actuator can be held on the hand plate. Preferably, the actuator is held on the hand plate via a compensating device. Here, the compensating device can enable length compensation, transverse compensation, height compensation and/or angular compensation. With regard to the definitions of the degrees of freedom of compensation and the further design of the compensating device, what has been said above about the compensating device of the holding device applies accordingly.

It is also possible that the actuator is connected to the hand plate via a joint, for example with the possibility of pivoting about a pivot axis which is oriented vertically to the back of the hand, or with a pivot axis which is oriented transversely to the longitudinal axis of the elongated finger and extends in the plane of the back of the hand or parallel thereto.

In the finger exoskeleton, the actuator can actuate a plunger. In this case, the plunger can form the joint head, while the actuator forms the joint sockets. Alternatively, it is possible that the plunger forms the joint sockets and the actuating member forms the joint head.

A further proposal is provided by a method of manufacturing a finger orthosis as explained above. In this method, a proximal scaling factor PSKF is first determined on the basis of the length of the first phalanx of a patient. Furthermore, a distal scaling factor DSKF is determined based on the length of the patient's second phalanx. The actual coordinates of the actuation joint (x_{P,24}, y_{P,24}) are then determined by converting first standard coordinates (x_{N,24}, y_{N,24}), and the actual distance A_{P,24-18} between the actuation joint and the first joint is determined by converting a first standard distance A_{N,24-18} and the actual distance A_{P,56-18} between the PIP body joint and the first joint is determined by converting a second standard distance A_{N,56-18}, the conversion being carried out in each case using the proximal scaling factor PSKF. It is possible to additionally determine the actual distance A_{P,56-18} of a finger middle joint arranged in the finger exoskeleton from the first joint by converting a second standard distance A_{N,56-18}, also by use of the proximal scaling factor PSKF. Furthermore, the actual coordinates (x_{P,21}, y_{P,21}) of the first coupling rod joint are determined by converting second standard coordinates (x_{N,21}, y_{N,21}), the actual distance A_{P,19-22} of the second joint from the second coupling rod joint is determined by converting a third standard distance A_{N,19-22} and the actual distance A_{P,21-22} of the first coupling rod joint from the second coupling rod joint is determined by converting a fourth standard distance A_{N21-22}, this conversion being carried out in each case using the distal scaling factor DSKF. Such a method enables particularly simple dimensioning and scaling to different geometries of the patient's hand and fingers, whereby the method makes use of the design of the finger orthosis as described here. However, deviations of the distances (A_{P}) and coordinates (x_{P}, y_{P}) of +/−20%, +/−10% or +/−5% from the above dimensions are also possible. The deviations can be made, for example, for the purpose of taking into account deviations of a specific anatomy from an average anatomy or to bring about different kinematics or movement ranges of the finger orthosis.

For one proposal, the proximal scaling factor PSKF and/or the distal scaling factor DSKF are determined by means of an automatic image processing or on the basis of a 3D scan technology. It is possible, for example, that one or more images with different views and/or different flexion positions of the relevant finger or a 3D scan as a basis are used for automatic image processing. The automatic image processing then determines the locations of the joints of the finger and the lengths of the phalanges, on the basis of which the proximal scaling factor PSKF and/or the distal scaling factor DSKF can then be determined.

It is possible that a 3D model of the members of the finger orthosis is created on the basis of the determined dimensions and that the members are manufactured by means of an additive manufacturing process, in particular by means of 3D printing.

In a manufacturing method, it is also possible to manufacture a further, second finger orthosis which is intended for a finger in which only the first and second phalanx are moved by means of the finger orthosis. This finger orthosis then has a second phalanx accommodation, while no third phalanx accommodation is hinged to the second phalanx accommodation. It is possible that the additional finger orthosis is intended for a finger embodied as a thumb. It is also possible that the finger orthosis is intended for a finger in which the third phalanx has been amputated. Finally, it is also possible that the further finger orthosis is intended for a finger in which the DIP finger joint is immobilized. In these cases, the third phalanx accommodation may not be present at all. In the latter case of immobilization of the DIP phalanx, the third phalanx accommodation may also be rigidly held on the second phalanx accommodation. The second finger orthosis can be dimensioned using the same dimensioning rules as for the first phalanx orthosis as described above, in which a third phalanx accommodation is hinged to the second phalanx accommodation. In this case, however, it is only necessary to determine a proximal scaling factor, whereas it is not necessary to determine the distal scaling factor. The proximal scaling factor is then used to determine the coordinates of the actuation joint, of the distance between the actuation joint and the first joint and of the distance between the PIP body joint and the first joint in accordance with the explanations for the manufacturing of the first finger orthosis. This makes it easy to manufacture different finger orthoses, for example for a thumb on the one hand and for a finger with the first, second and third finger joints on the other hand.

Advantageous developments of the invention result from the claims, the description and the drawings.

The advantages of features and of combinations of a plurality of features mentioned in the description only serve as examples and may apply alternatively or cumulatively, without the necessity of embodiments according to the invention having to obtain these advantages.

The following applies with respect to the disclosure—not the scope of protection—of the original application and the patent: Further features may be taken from the drawings, in particular from the illustrated geometries and the relative dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to the features mentioned in the claims, or the claimed features may be the only features of the claimed subject.

The reference signs contained in the claims are not limiting the scope of the claims. Their sole intention is to make the claims easier to understand.

### BRIEF DESCRIPTION OF THE DRAWINGS

In the following, the invention is further explained and described with reference to preferred embodiments shown in the figures.

FIG. 1 shows an exploded view of a finger exoskeleton.

FIG. 2 shows a three-dimensional view of a finger exoskeleton applied to a patient's hand, with the finger arranged in the finger orthosis being extended.

FIG. 3 shows the finger exoskeleton according to FIG. 2 in a three-dimensional representation with the different degrees of freedom marked.

FIG. 4 shows a detail IV of the exploded view according to FIG. 1.

FIG. 5 shows a highly schematized view of the kinematics of a finger exoskeleton as shown in FIGS. 1 to 4.

FIG. 6 shows a side view of the finger exoskeleton according to FIGS. 2 to 5 with the finger extended in the finger orthosis.

FIG. 7 shows the finger exoskeleton according to FIG. 6 in a corresponding side view, here the finger arranged in the finger orthosis being partially flexed.

FIG. 8 shows the finger exoskeleton according to FIG. 6 in a corresponding side view, here the finger arranged in the finger orthosis being fully flexed.

FIG. 9 shows a top view of a hand with a finger exoskeleton according to FIGS. 2 to 8, here the finger arranged in the finger orthosis being stretched and not spread out.

FIG. 10 shows a view corresponding to FIG. 9, in which the finger arranged in the finger orthosis is stretched and spread out.

FIG. 11 shows a highly schematized method for patient-specific dimensioning of a finger exoskeleton.

FIG. 12 shows a three-dimensional view of a hand plate with two finger orthoses held on it, which are intended here for interaction with a thumb and an amputated finger.

FIG. 13 shows a top view of a hand with a finger orthosis in a partial section with a cut parallel to the back of the hand through the hand plate, the finger orthosis comprising an adjusting device for fine adjustment of the position of the actuation joint and/or of a holding device for the actuator of the finger orthosis.

### DETAILED DESCRIPTION

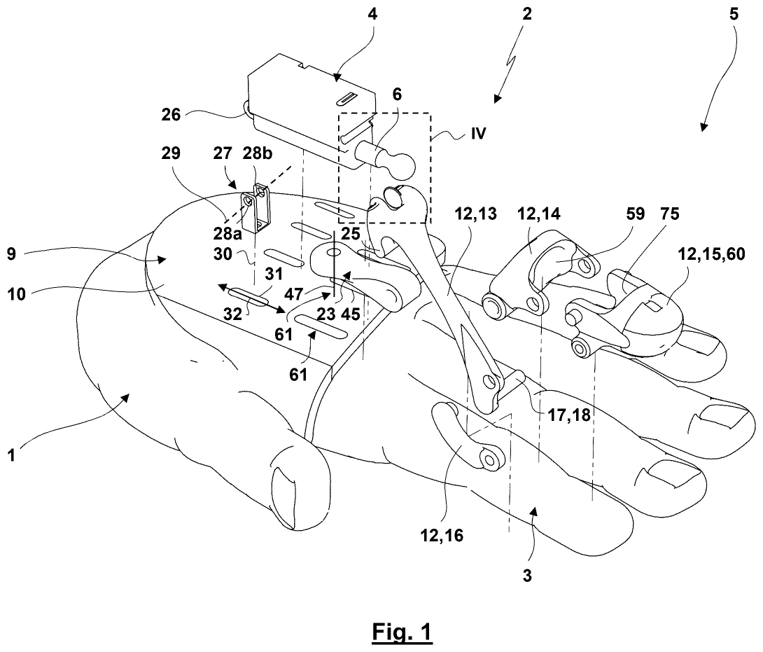

FIG. 1 shows a three-dimensional representation of a hand 1. The following shows an example of the application of a finger exoskeleton 2 to a finger 3, which is the index finger. However, the finger exoskeleton 2 can alternatively be attached to any other finger, namely the middle finger, the ring finger and the little finger. It is also possible that the finger exoskeleton 2 is linked to several fingers, in which case a corresponding number of actuators 4 and finger orthoses 5 are present.

The finger exoskeleton 2 has or consists of the actuator 4 and the finger orthosis 5. The actuator 4 comprises a translationally movable plunger 6. The actuator 4 with the plunger 6 forms the active part of the finger exoskeleton 2, while the finger orthosis 5 forms the passive part of the finger exoskeleton 2. The plunger 6 is coupled to the finger orthosis 5 via a coupling connection 7, which is embodied here as a coupling joint 8.

The finger orthosis 5 has a hand accommodation 9, by means of which the finger orthosis 5 can be fixed or held on the hand 1 of a patient. In this case, the hand accommodation 9 extends around the hand in the region of the metacarpal bones, in the region of the carpal bones and/or the wrist, with the thumb protruding freely from the hand accommodation 9. In the embodiment shown, the hand accommodation 9 has a hand plate 10. The hand plate 10 rests against the back of the hand 1. The hand plate 10 may comprise linkage regions 11 for straps, belts, Velcro fasteners or other attachment means known in principle for orthoses. With these attachment means, the hand accommodation 9 forms a through recess through which the hand 1 can extend. It is possible that the attachment means enable the hand 1 to be adjusted and clamped.

The finger orthosis 5 comprises at least or exactly four members 12. For the embodiment shown, the finger orthosis 5 comprises an actuating member 13, a second phalanx accommodation 14, a third phalanx accommodation 15 and a coupling rod 16, which, as will be explained below, are connected to one another via joints 17.

The plunger 6 of the actuator 4 and the actuating member 13, the second phalanx accommodation 14 and the third phalanx accommodation 15 of the finger orthosis 5 form a link chain. For this purpose, the plunger 6 is connected to the actuating member 13 by means of the coupling joint 8, the actuating member 13 is connected to the second phalanx accommodation 14 by means of a first joint 18 and the second phalanx accommodation 14 is connected to the third phalanx accommodation 15 by means of a second joint 19. A constraining guide 20 between the second phalanx accommodation 14 and the third phalanx accommodation is provided by means of the coupling rod 16. For this purpose, the coupling rod 16 is articulated in the proximal end region in a first coupling rod joint 21 on the actuating member 13. Here, the first coupling rod joint 21 is arranged at a distance (in particular at a distance in the direction of the longitudinal extension between the coupling joint 8 and the first joint 18) from the first joint 18. It is possible that the coupling joint 8, the first joint 18 and the first coupling rod joint 21 are arranged at the corners of a triangle, wherein the distance of the first coupling rod joint 21 from the first joint 18 can be smaller by a factor of at least 3 or at least 4 than the distance of the coupling joint 8 from the first joint 18. The other end region of the coupling rod 16 is articulated in a second coupling rod joint 22 to the third phalanx accommodation 15. Here, the second coupling rod joint 22 is arranged at a distance from the second joint 19 and, in particular, below it.

A holding device 23 is held on the hand accommodation 9, in this case the hand plate 10. The actuating member 13 is articulated to the holding device 23 in an actuation joint 24. The actuation joint 24 is arranged at a distance from the coupling joint 8 and between the coupling joint 8 and the first joint 18 as well as the first coupling rod joint 21, the distance of the actuation joint 24 from the coupling joint 8 preferably being smaller than the distance of the coupling joint 8 from the first joint 18 by a factor of more than 3, by a factor more than 4 or more than 4.5. Furthermore, the actuation joint 24 is arranged below the connecting axis between the coupling joint 8 and the first joint 18. For this purpose, the actuation joint 24 can be arranged in the region of a bar 25 or a bulge of the actuating member 13.

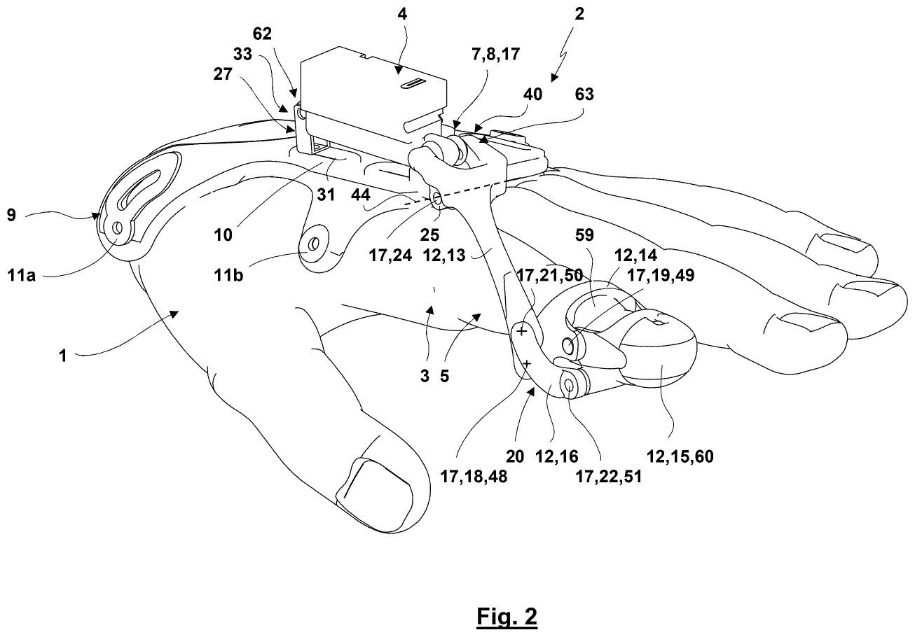

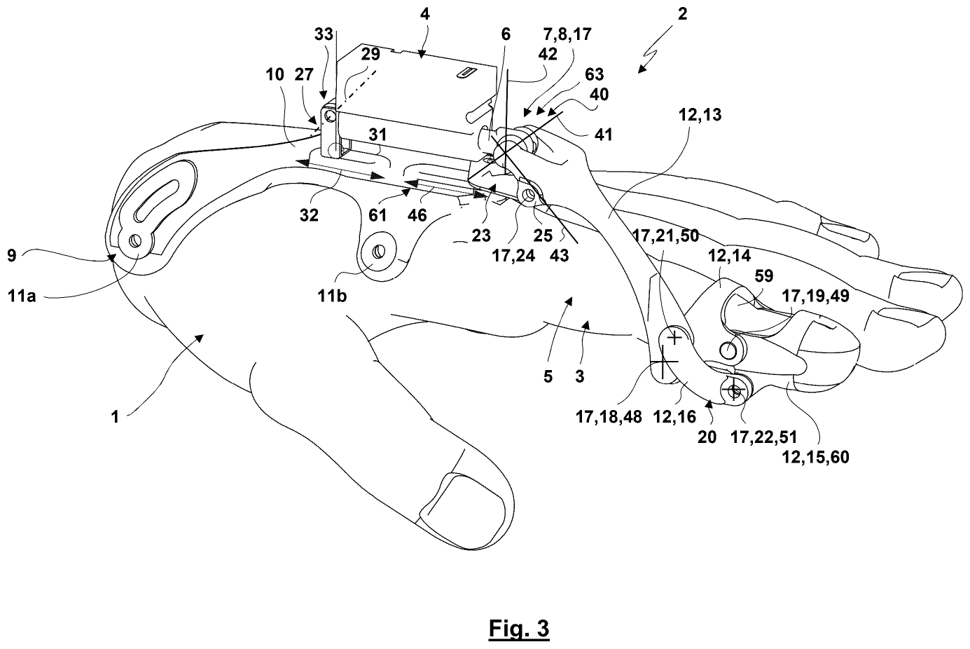

The various degrees of freedom provided by the joints 17 are explained below with reference to FIGS. 1 to 3. It is possible here that the joints 17 for other embodiments do not comprise some of the degrees of freedom explained or that further degrees of freedom are present. It is also possible that the degrees of freedom of the joint 17 are not provided by means of a single joint connection of the joint, but are provided by means of various joint connections, which are then arranged closely adjacent to one another.

The actuator 4 is attached to a U-shaped holding device 27 in the proximal end region by means of an eye or a bearing eye 26. For this purpose, the side legs of the U-shaped, upwardly open holding device 27 have aligned bores 28. A bearing bolt, which is not shown here, can extend through these bores 28 and the eyelet or bearing eye 26, so that the actuator 4 can pivot about a pivot axis 29 defined by the bearing bolt, the bores 28 and the eyelets or bearing eyes 26. The pivot axis 29 is oriented parallel to the back of the hand and the hand plate 10 and transverse to the longitudinal extension of the stretched finger 3. The base leg of the U-shaped holding device 27 rests on the upper side of the hand plate and is connected or screwed to it via a bearing bolt, which is not shown. The bearing bolt provides a pivot axis 30 oriented vertically to the hand plate 10. The bearing bolt can be accommodated in an elongated hole 31 in the hand plate 10, thus providing a translational degree of freedom 32 which is oriented in the direction of the longitudinal axis of the finger 3 when the finger 3 is extended. In this way, an actuator joint 33 is formed, which connects the actuator 4 to the hand plate 10 and provides three degrees of freedom with the pivot axis 29, the pivot axis 30 and the translational degree of freedom 32. In this way, the actuator joint 33 forms a compensating device 62. It is possible that the translational degree of freedom 32 is used to adjust the finger exoskeleton 2 to the anatomy of the patient, so that the translational degree of freedom 32 is fixed after adjustment, while the degrees of freedom ensured by the pivot axes 29, 30 are also active during operation.

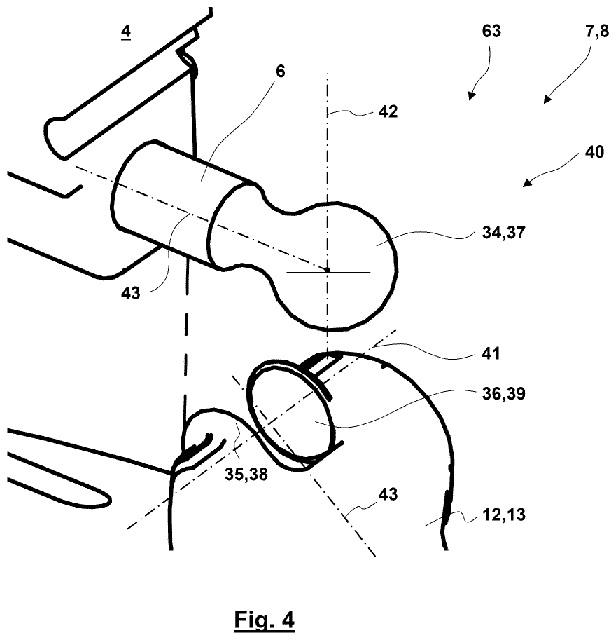

Detail IV (see FIG. 4) shows the coupling joint 8 between the plunger 6 and the actuating member 13. It can be seen that the coupling joint 8 comprises a joint body 34 which is pivotably received between two joint body accommodations 35, 36. For the embodiment shown, the joint body 34 is embodied as a partially spherical joint head 37, while the joint body accommodations 35, 36 are embodied as joint sockets 38, 39. The joint sockets 38, 39 form cheeks. If a coupling force transmitted via the coupling joint 8 becomes so great that an elastic deformation of the cheeks occurs, the joint head 37 can exit from the joint sockets 38, 39, thus providing an overload protection 40. Preferably, the coupling joint 8 ensures a pivotal degree of freedom about a pivot axis 41 which is oriented parallel to the hand plate 10 and is oriented transversely to the longitudinal extension of the finger 3 in the extended state. By means of pivoting about this pivot axis 41, a flexion and extension movement of the finger orthosis 5 can be provided. Furthermore, the coupling joint 8 provides pivoting about a pivot axis 42, which is oriented vertically to the hand plate 10. By means of the pivot axis 42, pivoting can be performed for abduction and adduction of the finger orthosis 5. Finally, the coupling joint 8 provides a rotational degree of freedom about a rotational axis 43, which corresponds to the longitudinal axis of the plunger 6 or the longitudinal axis of the actuating member 13. This rotational degree of freedom provides a relative rotation of the finger 3 about its longitudinal axis, which can occur, for example, during the flexion and extension movement of the finger.

The actuation joint 24 between the holding device 23 and the actuating member 13 has only one pivot axis 44, which is oriented parallel to the hand plate 10 and transverse to the longitudinal axis of the actuating member 13. The holding device 23 is connected to an elongated hole 45 of the hand plate 10 via a bearing screw. The elongated hole 45 provides a translational degree of freedom 46, which preferably serves to adjust the finger orthosis 5 for adaptation to the specific anatomy of the patient and can be fixed after adjustment, as well as a pivot axis 47, which is oriented vertically to the hand plate 10. A use of a degree of freedom about this pivot axis 47 can serve, on the one hand, to adapt to the specific anatomy of the patient and, on the other hand, to enable abduction and adduction.

The first joint 18, the second joint 19, the first coupling rod joint 21 and the second coupling rod joint 22 each provide pivot axes 48, 49, 50, 51 which are parallel to each other and oriented vertically to a plane in which the actuating member 13, the second phalanx accommodation 14 and the third phalanx accommodation 15 extend and in which these are moved during flexion and extension of the finger orthosis 5. It is possible that the first joint 18, the second joint 19, the first coupling rod joint 21 and/or the second coupling rod joint 22 are embodied as having bearing eyes and a bearing pin extending through the bearing eye. However, it is also possible that bearing extensions received in bearing eyes are embodied as integral parts of one of the associated members 12, in which case assembly is also possible by means of an elastic widening of the cheeks forming the bearing eyes.

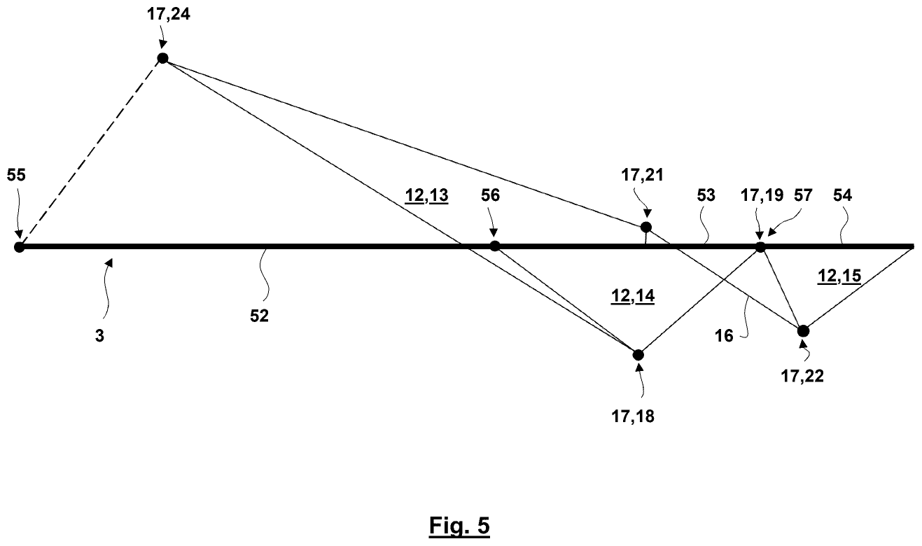

In FIG. 5, the finger 3 with the first phalanx 52, the second phalanx 53 and the third phalanx 54 is first shown schematically with a thick line. The second phalanx 53 is supported or accommodated in the second phalanx accommodation 14 and is connected to the actuating member 13 exclusively via the first joint 18. In the distal end region, the second phalanx accommodation 14 is connected via the second joint 19 to the third phalanx accommodation 15, which supports or accommodates the third phalanx 54. Furthermore, the coupling rod 16 can be seen with its articulation with the coupling rod joints 21, 22 on the actuating member 13 and on the third phalanx accommodation 15. The first phalanx 52 is articulated in the proximal end region via the MCP body joint 55 to the associated metacarpal bone. The distal end region of the first phalanx 52 is connected to the second phalanx 53 via the PIP body joint 56. The distal end region of the second phalanx 53 is in turn connected to the third phalanx 54 via the DIP body joint 57. It can be seen in FIG. 5 that only an exact alignment of the second joint 19 to the DIP body joint 57 has to be ensured for the finger orthosis 5, while the other joints 18, 21, 22, 24 can be arranged remote from the MCP body joint 55 and the DIP body joint 57, which can simplify the adaptation of the finger orthosis 5 to the specific anatomy of a patient. It can also be seen that the actuation joint 24 is arranged above or dorsal to the back of the hand, while the first joint 18 is arranged below the finger, in this case below the second phalanx 53. Furthermore, it can be seen in FIG. 5 that the effective axis between the first joint 18 and the second joint 19, on the one hand, and the effective axis of the coupling rod 16, i.e. the effective axis between the coupling rod joints 21, 22, on the other hand, cross each other. In the stretched and horizontal position of the finger 3 shown in FIG. 5, the second coupling rod joint 22 is arranged below the second joint 19 and in the lower region of the third phalanx accommodation 15.

For dimensioning the finger orthosis 5, individual relative dimensions, several relative dimensions or all relative dimensions can be taken from the dimensions shown in FIG. 5, whereby deviations of +/−20%, +/−15%, +/−10% or +/−5% from these dimensions or also from the dimensions described below are also possible, for example.

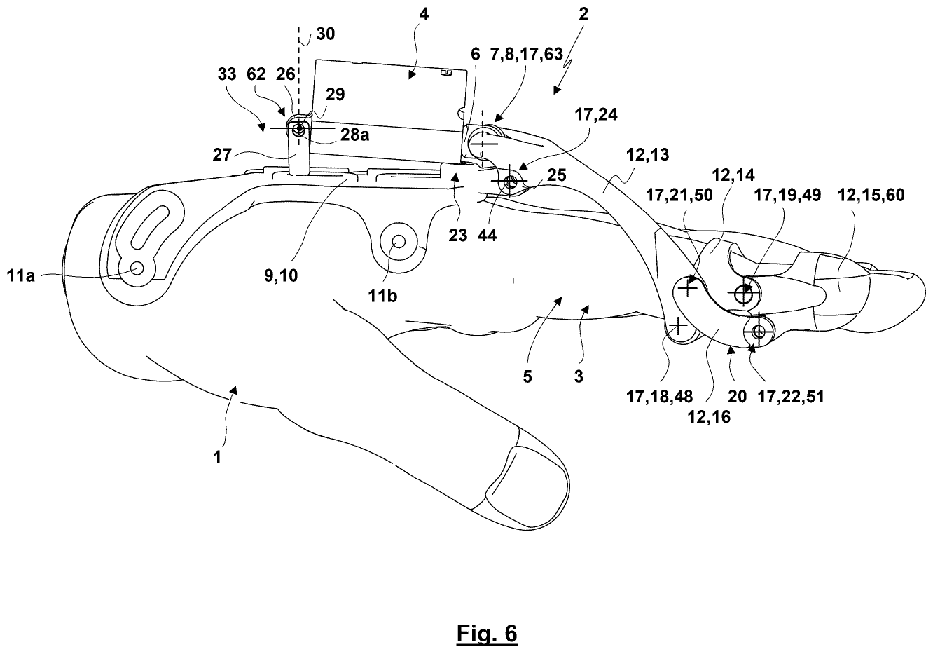

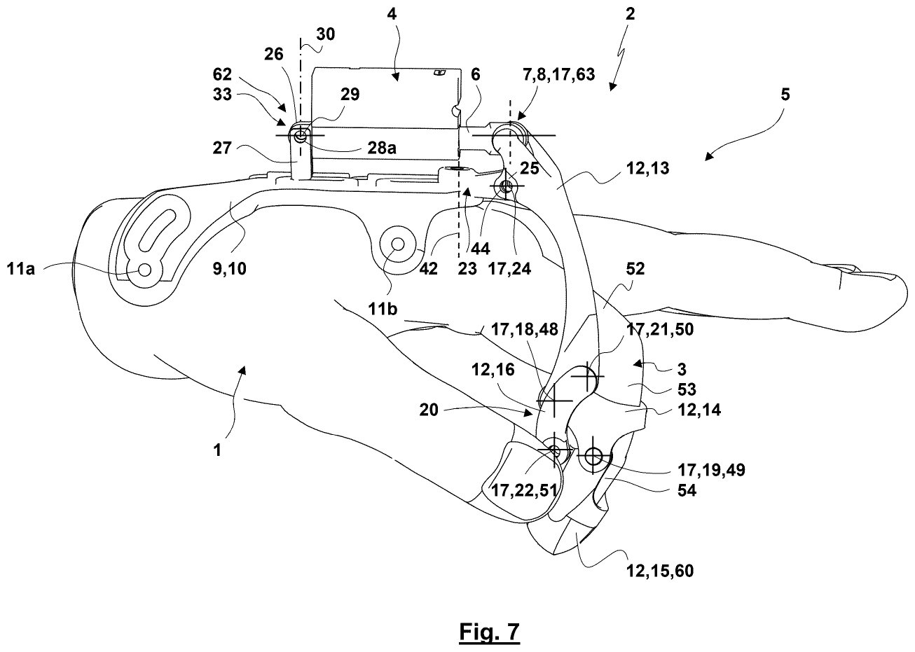

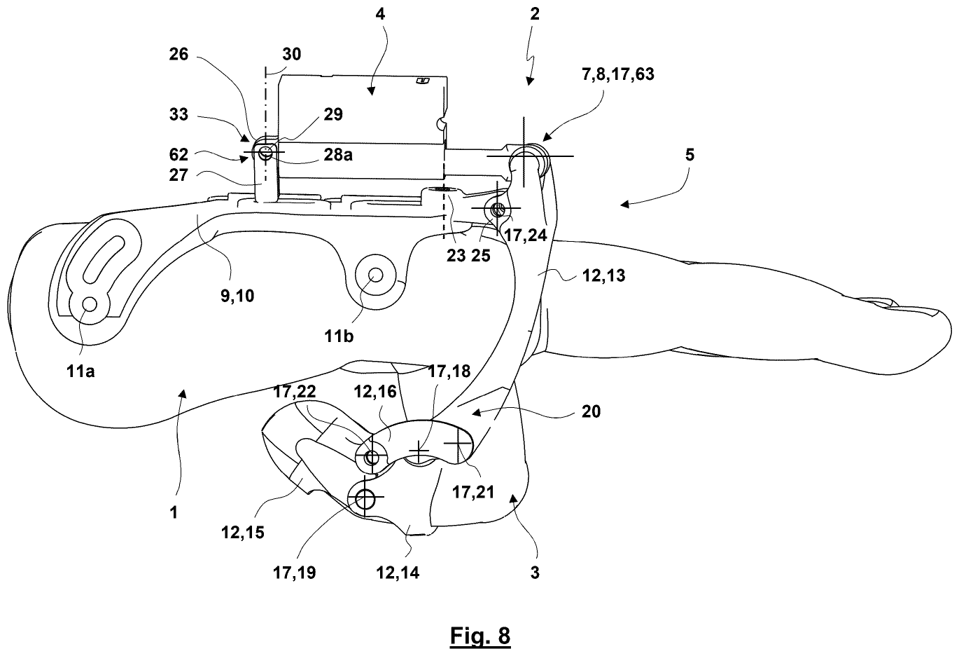

FIGS. 6 to 8 show the finger exoskeleton 2 on a hand 1 and a finger 3 in an extended position of the finger 3 (FIG. 6), in a partially flexed position of the finger 3 (FIG. 7) and in a fully flexed position of the finger 3 (FIG. 8). It is possible that the range of movement of the actuator 4 and/or the finger orthosis 5 is restricted compared to this maximum range of movement, which can be ensured by limiting the stroke of the actuator 4 and/or by fixed or adjustable stops of the finger orthosis 5 and its joints 17.

The selected arrangement can, for example, achieve the advantageous effect that the transmission of the stroke of the actuator 4 with the plunger 6 to the relative pivoting between the second phalanx accommodation 14 and the third phalanx accommodation 15 is relatively small in the area of the stretched position. As a result, for the stretched position of the finger orthosis 5 shown in FIG. 5, a very sensitive adjustment of the stretched position in correlation with the end position of the actuator 4 is possible, whereby overstretching of the second phalanx accommodation 14 and the third phalanx accommodation 15 with the phalanges 53, 54 arranged therein, which is to be avoided, can be reliably avoided.

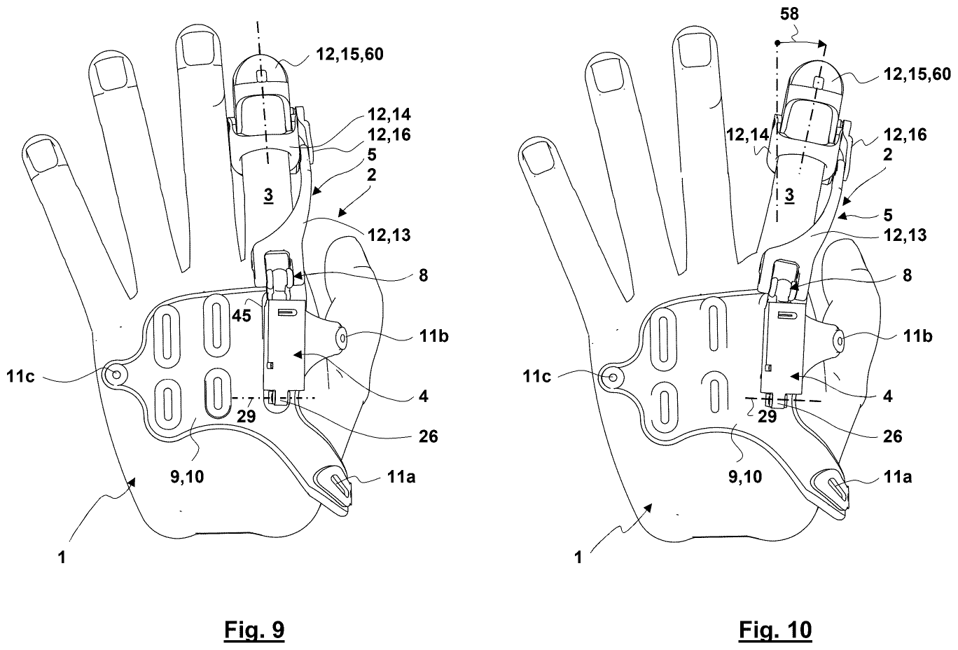

FIGS. 9 and 10 show a top view of a finger exoskeleton 2 with a hand 1 and the finger 3. In FIG. 9, the finger 3 is not spread apart, while in FIG. 10 the finger is spread apart. It can be seen that regardless of the spreading angle 58, the orientation of the actuator 4 does not change or only changes to a small extent. In contrast, the alignment of the finger orthosis 5 changes depending on the spreading angle 58. Such a compensating movement is made possible by the coupling joint 8, which, as explained, is embodied as a ball joint with a joint head 37 and the joint sockets 38, 39. Compensation of a spreading angle 58 as a result of abduction and adduction is achieved, as explained above, by a pivot movement about the pivot axis 42.

In addition to adapting the dimensions to the specific anatomy of the patient, the dimensions, the stroke of the actuator 4 and the possible travel of the finger orthosis 5 with its members 12 can also be adapted to a clinical picture and functional limitations of the hand 1 and the finger 3.

It is possible that the same finger orthosis 5 can be used with different actuators 4 and/or hand accommodations 9.

For the illustrated embodiment, the second phalanx accommodation 14 is ring-shaped so that the second phalanx 53 can extend through a through recess 59 of the second phalanx accommodation 14. In the upper half, the annular body of the second phalanx accommodation 14 has two distal extensions which form the bearing eyes for the second joint 19. In contrast, the first joint 18 is arranged in the lower end region laterally on the annular body of the second phalanx accommodation 14.

The third phalanx accommodation 15 forms an end cap 60, which forms a (blind hole) recess 75, in which the fingertip of the third phalanx 54 can be received. On the upper side or in the center, extensions extend from the end cap 60 in the proximal direction, which form a bearing protrusion or a bearing eye for the second joint 19. On the other hand, the second coupling rod joint 22 is embodied as a lower lateral protrusion.

If the finger 3 is injured, the finger may tend to assume a partially flexed position. The reason for this is that the partial flexion position can reduce pain caused by the strain on the injured muscular structures. For this reason, the phalanx accommodations 14, 15 are embodied such that they can also press against the finger 3 from below in order to cause the finger 3 to stretch. This is ensured by the ring-shaped enclosure of the phalanges 53, 54 by the phalanx accommodations 14, 15.

On the one hand, the proposed finger exoskeleton 2 allows the finger exoskeleton 2 to be adjusted when it is put on for fitting and adjustment. On the other hand, the finger exoskeleton 2 enables compensating movements of the joints 17 in the different operating positions. Here, the holding device 23 forms a compensating device 61, as this enables longitudinal displacement along the elongated hole 45 and pivoting about the pivot axis 47. The actuator joint 33 also forms a compensating device 62, as it enables the actuator 4 to be pivoted about the pivot axis 29, to be pivoted about the pivot axis 30 and to be displaced along the elongated hole 31. Finally, the coupling joint 8 in the form of a ball joint also forms a compensating device 63.

The second phalanx accommodation 14 and the third phalanx accommodation 15 completely enclose the associated phalanx 53, 54, which provides improved guidance. Here, contact with the phalanx 53, 54 is established on both the palmar and dorsal sides to enable flexion and extension of the finger 3 by the actuator 4. Furthermore, the second phalanx accommodation 14 and the third phalanx accommodation 15 contact the associated phalanx 53, 54 on both the lateral and medial sides. In this way, improved stabilization and guidance of the movement of the finger 3 can be achieved.

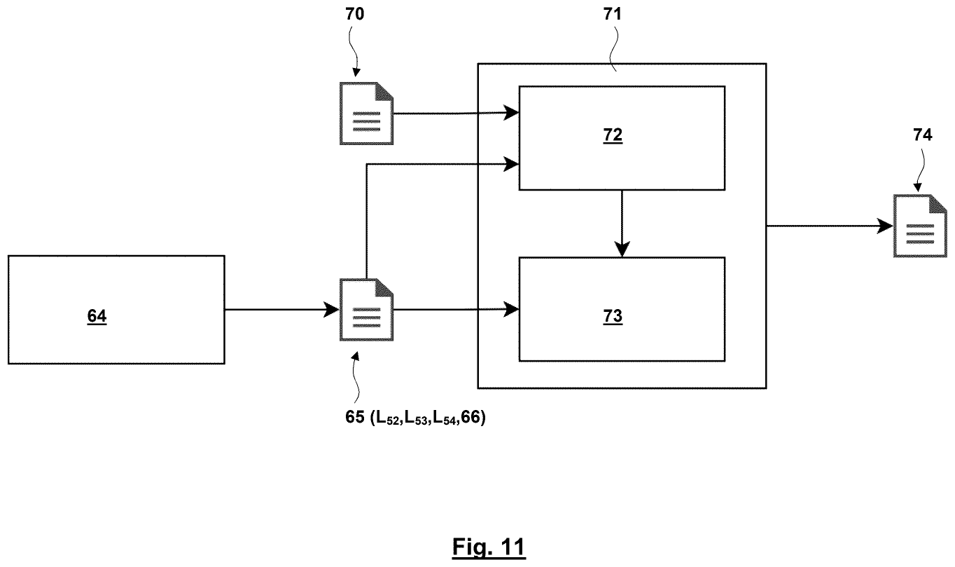

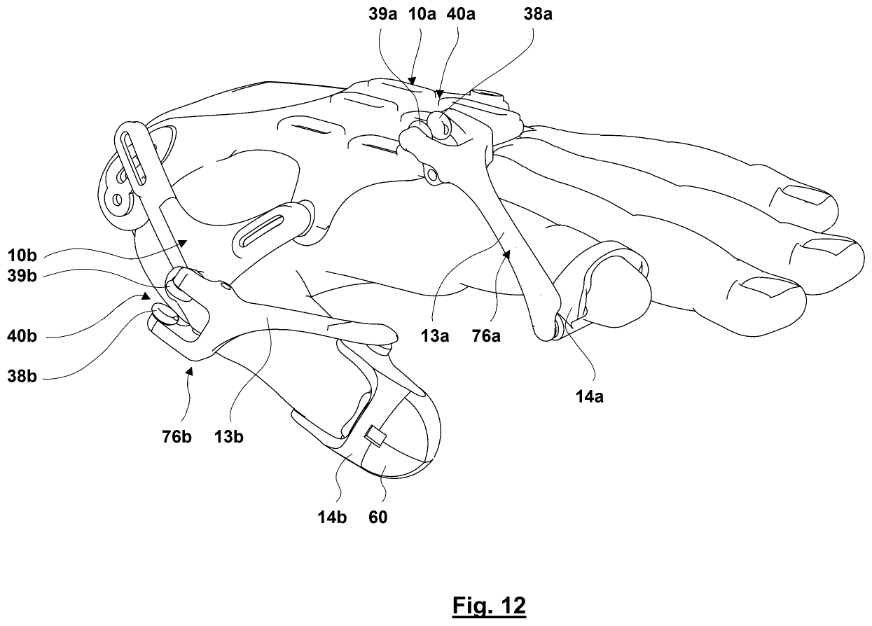

FIG. 11 schematically shows a method for dimensioning and manufacturing a finger orthosis 5. In a method step 64, the anatomy of the hand 1 and in particular of the patient's finger 3 is determined. The result of the method step 64 is a set of anatomical measurements 65, which may include the length L₅₂ of the first phalanx 52, the length L₅₃ of the second phalanx 53 and/or the length L₅₄ of the third phalanx 54, which are required for determining the dimensions of the kinematic equivalent circuit diagram in FIG. 5. Furthermore, the set 65 may contain further measurement results 66 which may, for example, relate to the cross-sectional geometry of a phalanx 52, 53, 54 and are required for the suitable design of the through recess 59 of the second phalanx accommodation 14 and the recess 75 of the end cap 60. It is also possible that the set 65 includes information regarding a design or scaling of the finger orthosis according to preferences, specific requirements and/or a condition of the patient. For example, it is possible that areas of the hand, of the finger or of the skin with which contact is to be avoided (e.g. a suture after a surgical procedure) are specifically omitted, that the patient's preferences as to how the orthosis should be worn are taken into account or that functional requirements based on standardized healthcare specifications, healthcare protocols or healthcare regulations are taken into account.

Furthermore, data 70 on mechanical standard coordinates (x_{N}, y_{N}) and standard distances (A_{N}) are used in the method.

In the present application text, the coordinates are labeled (x, y) and distances are labeled A. In the coordinates, the coordinate (0,0) coincides with the MCP body joint 55 (whereby any coordinate transformation or conversion is possible). The index N denotes a standard distance or a standard coordinate, while the index P describes an actual intended distance or the coordinates for the specific adaptation of the finger orthosis 5 to a patient. Furthermore, the indices contain references to the reference numbers of the respective joints and members or, for the specification of a distance or for a length of a distance, the reference numbers of the joints, separated by a hyphen, between which the distance or length is formed.

The data 70 may include standard distances P_{N}, standard coordinates (x_{N}, y_{N}) or predetermined length ratios and/or may be parameters relating to functional limitations of the finger of the patient for which the finger orthosis 5 is intended. The set of anatomical measurements 65 and the data 70 are then processed in a processing block 71. In a method step 72, the dimensions of the finger orthosis 5 for the specific patient whose measurements 65 are taken as a basis are determined on the basis of the set of measurements 65 and the data 70. A 3D model is then determined in a method step 73 on the basis of the dimensions determined in method step 72. As output, the processing block 71 generates data 74 of the 3D model, which is sent to an additive manufacturing device, in particular a 3D printer. The additive manufacturing device then produces the finger orthosis 5 specifically adapted to the patient. In method step 72, the dimensions of the kinematic equivalent circuit diagram according to FIG. 5 are determined specifically for the respective patient.

FIG. 5 shows that it is possible to divide the finger orthosis 5 into two mechanical subsystems, namely into
a proximal mechanism and
a distal mechanism.

The proximal mechanism consists of a crossed 4-member mechanism with
the actuation joint 24,
the MCP body joint 55,
the first joint 18 and
the PIP body joint 56 and
the connection between the actuation joint 24 and the first joint 18, which is provided by the actuator 13,
the connection between the PIP body joint 56 and the first joint 18, which is provided by the second phalanx 53, and
the connection between the MCP body joint 55 and the PIP body joint 56, which is provided by the first phalanx 52.

The actuation of the proximal mechanism is caused by the rotation about the actuation joint 24 as a result of the actuation by the actuator 4. The range of movement of the proximal mechanism is largely determined by the ratios of the aforementioned connections thereof and, in particular, the relative arrangement of the actuation joint 24 relative to the MCP body joint 55 (coordinates (x_{P,24}, y_{P,24}). Changes in these dimensions result in different minimum and maximum angles of the joints 17, allowing for biomechanical user customization. In the proximal mechanism, the present finger orthosis 5 utilizes guidance by the phalanges 52, 53 and the associated body joints 55, 56 in addition to the guidance by the finger orthosis 5.

The distal mechanism is a dyad mechanism which comprises
the second joint 19,
the first coupling rod joint 21 and
the second coupling rod joint 22
   and
the connection between the second joint 19 and the second coupling rod joint 22, which is provided by the third phalanx 54 and the third phalanx accommodation 15, and
the connection between the first coupling rod joint 21 and the second coupling rod joint 22, which is provided by the coupling rod 16,
   comprising. This dyad mechanism is actuated by a relative displacement of the first coupling rod joint 21 relative to the PIP body joint 56. Thus, the distal mechanism is actuated by the actuation of the proximal mechanism, resulting in a single actuator 4 being used to move all of the phalanges 52, 53, 54. The range of movement of the second joint 19, and thus of the DIP body joint 57, depends on the length ratios of the aforementioned connecting sections of the distal mechanism.

Dimensioning of the specifically adapted finger orthosis 5 according to FIG. 5 is carried out with the following standard coordinates (x_{N}, y_{N}) and standard distances (A_{N}):

| | | Standard distance A_{N} or |
|---|---|---|
| Mechanism | Component to be dimensioned | Standard coordinate (x_{N}, y_{N}) |
| proximal | Standard coordinate MCP body joint 55 | (x_{N, 55}, y_{N, 55}) = (0.0, 0.0) |
| | Standard length of first phalanx 52 | A_{N, 55-56} = 5.00 |
| | Standard coordinates of actuation joint 24 | (x_{N, 24}, y_{N, 24}) = (1.50, 2.00) |
| | Standard length connection actuation joint | A_{N, 24-18} = 5.92 |
| | 24-first joint 18 | |
| | Standard length connection PIP body joint | A_{N, 56-18} = 1.90 |
| | 56-first joint 18 | |
| | Standard coordinates PIP body joint 56 | (x_{N, 56}, y_{N, 56}) = (A_{N, 55-56}, 0.00) |
| distal | Standard length connection | A_{N, 57-56} = 2.80 |
| | DIP body joint 57-PIP body joint 56 | |
| | Standard coordinate | (x_{N, 21}, y_{N, 21}) = (6.60 − |
| | first coupling rod joint 21 | A_{N, 55-56}, 0.20) |
| | Standard length connection second joint | A_{N, 19-22} = 1.00 |
| | 19-second coupling rod joint 22 | |
| | Standard length connection first coupling | A_{N, 21-22} = 1.98 |
| | rod joint 21-second coupling rod joint 22 | |

The lengths, distances and coordinates are specified in centimeters.

The following calculations can be carried out in method step 72:

In a method step 72a, a proximal scaling factor PSKF is determined via

$$PSKF = {L}_{52} / {A}_{N , 55 - 56} .$$

In a method step 72b, the coordinates x_{P,24}, y_{P,24} of the actuation joint are then determined as follows:

$$\begin{matrix}{x}_{P , 24} = {x}_{N , 24} * PSKF ; \\ {y}_{P , 24} = {y}_{N , 24} * PSKF\end{matrix}$$

In a method step 72c, the lengths of the connecting distances of the proximal mechanism are determined as follows:

$$\begin{matrix}{A}_{P , 55 - 56} = {A}_{N , 55 - 56} * PSKF \\ {A}_{P , 55 - 18} = {A}_{N , 55 - 18} * PSKF \\ {A}_{P , 24 - 18} = {A}_{N , 24 - 18} * PSKF\end{matrix}$$

The proximal mechanism is thus dimensioned in method steps 72a, 72b, 72c. The distal mechanism is dimensioned as follows: In a method step 72d, a distal scaling factor DSKF is determined:

$$DSKF = {L}_{53} / {A}_{N , 57 - 56}$$

In a method step 72e, the coordinates x_{P,21}, y_{P,21} of the first coupling rod joint are determined as follows:

$$\begin{matrix}{x}_{P , 21} = ( 6.6 - {A}_{N , 55 - 56} ) * DSKF ; \\ {y}_{P , 21} = 0.2 * DSKF .\end{matrix}$$

Finally, in a method step 72f, the lengths of the connecting sections are determined as follows:

$$\begin{matrix}{A}_{P , 19 - 22} = {A}_{N , 19 - 22} * DSKF \\ {A}_{P , 21 - 22} = {A}_{N , 21 - 22} * DSKF\end{matrix}$$

In method step 72, the standard distances or standard lengths are thus taken as data 70 from the above table (or a memory with the values of the table) and the above formulae can then be used to calculate the specific coordinates and lengths or distances using the set of anatomical measurements with the lengths L₅₂, L₅₃.

In method step 73, a 3D model is created with all components of the finger orthosis 5 or finger exoskeleton 2 except for the actuator 4 and any screws, bolts or other prefabricated components. The 3D model is parameterized in a CRD software (e.g. “solidworks” (registered trademark)). Stored and measured data can be used to determine the 3D model, which can be
fundamental mechanical parameters, which are used together with the scaling factors to determine a mechanimus specific to the patient and/or
anatomical measurements, which are used to generate the phalanx accommodations 14, 15 in optimal adaptation to the diameter and external geometry of the phalanges and/or
a variety of parameters that can describe manufacturing-dependent and geometry-specific characteristics, and/or
parameters for a design or scaling of the finger orthosis according to preferences, specific requirements and/or a condition of the patient (e.g. parameters regarding an area of the hand, finger or skin to be specifically left out in order to avoid contact (e.g. a suture after a surgical procedure), parameters regarding preferences of the patient as to how the patient wishes to wear the orthosis, or parameters regarding functional requirements based on standardized healthcare specifications, healthcare protocols or healthcare regulations).

It is possible for the finger orthosis 5 to be manufactured completely as an assembly in the additive manufacturing process or for components to be manufactured separately with subsequent assembly, possibly with the addition of prefabricated components.

When dimensioning, the distance between the MCP body joint 55 and the actuation joint 24 is preferably chosen to be half as large as the length L₍₅₂₎. This ensures that there is a sufficient distance for the actuation joint 24 to avoid collision with the anatomy over the entire range of motion, while at the same time the distance is small enough to allow a slim design of the finger orthosis 5. Other designs of this distance are certainly possible.

The four member mechanism is crossed. This may be critical for some embodiments, as it means that the first phalanx 52 and the connecting axis of the actuation joint 24 and the first joint 18 cross each other. Since the actuation joint 24 is disposed dorsal with respect to the proximal end of the first phalanx 52, the first joint 18 must be disposed on the palmar side of the second phalanx 52. Alternatively, the actuation joint 24 may be disposed on the palmar side of the second phalanx 52 (which would “flip” the four-bar mechanism). This alternative may prove to be disadvantageous, as in this case components of the finger orthosis 5 are arranged in an area into which the fingertip reaches with full flexing.

For the illustrated embodiment, the first coupling rod joint 21 is arranged dorsally. The second joint 19 coincides with the PIP body joint 56. Connections extend from both the first coupling rod joint 21 and the second joint 19 to the second coupling rod joint 22. In this way, a non-crossed dyad mechanism is formed. Here, the coupling rod 16 must cross the frontal plane to cause flexion of the DIP body joint 57 (and no undesired extension), which implies that the first coupling rod joint 21 must be arranged dorsally or palmar, while the opposite must be true for the second coupling rod joint 22. Here, the illustrated embodiment, in which the first coupling rod joint 21 is arranged palmar, is preferred for some embodiments, since the palmar arrangement of the first coupling rod joint 21 results in the distance of the first coupling rod joint 21 from the first joint 18 being very small, which may cause problems.

FIG. 12 shows a two-part hand plate 10a, 10b. A finger orthosis 76a is pivotably hinged to the hand plate 10a, while a finger orthosis 76b is pivotably hinged to the hand plate 10b. The finger orthosis 76a is intended for a finger in which the third phalanx 54 is amputated, the finger being the index finger for the embodiment shown. In contrast, the finger orthosis 76b is intended for the thumb.

The finger orthoses 76a, 76b are each connected to an actuator 4 in accordance with the preceding embodiment and each have a corresponding actuating member 13, to which a second phalanx accommodation 14a, 14b is articulated in accordance with the preceding embodiment. In this case, however, there is no coupling rod and no third phalanx accommodation due to the absence of the third phalanx 54.

Optionally, it is possible that (as shown for the finger orthosis 76b intended for the thumb) the second phalanx accommodation 14b comprises an end cap 60 or is connected to an end cap 60.

Except for the absence of the coupling rod and the third phalanx accommodation, the components of the finger orthoses 76 and the dimensions thereof may correspond in whole or in part to the finger orthosis 5 described in FIGS. 1 to 11.

Preferably, the finger orthoses 76 are also coupled to a plunger 6 of an actuator 4 with one degree of freedom about a pivot axis 42 for abduction and adduction. As shown, for this purpose the actuating member 13 can be fork-shaped in the end region facing the plunger 6 of the actuator and form joint sockets 38, 39, which can then optionally also form an overload protection 40.

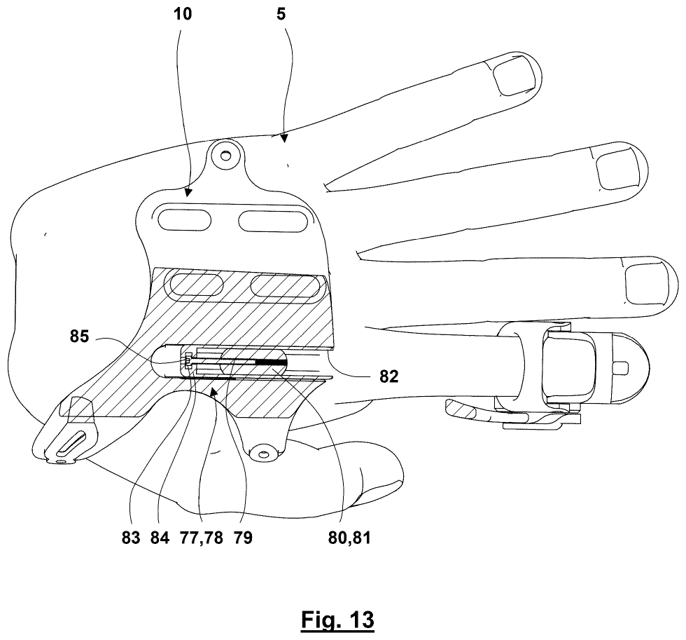

FIG. 13 shows an optional adjusting device 77. The actuation joint 24 can be adjusted by means of the adjusting device 77, preferably together with the holding device 23 along the translational degree of freedom 46. Preferably, a corresponding adjustment of the holding device 27 along the translational degree of freedom 32 also takes place via the adjusting device 77 together with the adjustment of the actuation joint 24.

For the embodiment shown in FIG. 13, the adjusting device 77 has a spindle drive 78. The spindle drive 78 comprises a spindle 79 and a spindle nut 80, which is embodied as a sliding block 81. The sliding block 81 is guided in a groove 82 in the underside of the hand plate 10 so as to slide with the translational degree of freedom 46, the sliding block 81 being secured against rotation in the groove 82. The holding device 27, the holding device 23 and/or the actuation joint 24 are held on the sliding block 81 in such a way that the aforementioned components are also moved when the sliding block 81 is moved along the groove 82. The spindle 79 has a head 83. The head 83 is axially supported on a stop 84 of the hand plate 10, but is rotatably mounted together with the spindle 79 relative to the stop 84. The head 83 has an engagement surface 85 for a tool with which a torsional moment can be applied to the spindle 79 to rotate it and thus to bring about a sliding movement of the sliding block 81 along the groove 82. For the embodiment shown, the engagement surface 85 is embodied as an internal polygon, in particular an internal hexagon. The adjusting device 77 is preferably embodied as flush with the underside of the hand plate 10 facing the hand surface or with a recess to this underside, so that the explained adjusting movement is possible and no disturbing interaction with the hand surface occurs.

In the finger orthosis 5 preferably
the actuating member 13 is held pivotably on the holding device 23 by the actuation joint 24 and/or
the actuation joint 24 is arranged in a vertical plane extending through the or a through recess 59 of the second phalanx accommodation 14 and the third phalanx accommodation 15 and/or
the first joint 18, by which the actuating member 13 is articulated to the second phalanx accommodation 14 and/or to the first coupling rod joint 21 are/is arranged laterally of the through recess 59 of the second phalanx accommodation 14 and/or
a hand accommodation 9 is provided, which can be held on a hand 1 in the region of the metacarpal bones and which holds the holding device 23 and/or
the hand accommodation 9 comprises a hand plate 10, wherein in particular the holding device 23, which is coupled to the actuating member 13 by the actuation joint 24, is held on the hand plate 10 or on the hand accommodation 9 and/or
the holding device 23 is connected to the hand plate 10 by a pivot bearing, which enables an angular change of the holding device 23 about a vertical pivot axis and/or
the hand plate 10 is formed in one single piece and/or
the hand accommodation 9 comprises a further hand plate and the hand plate 10 and the further hand plate are connected to each other via straps and/or
an actuation joint provides a degree of freedom for an abduction and an adduction about a pivot axis and/or
the actuation joint 24 is embodied as a ball joint and/or comprises the overload protection and/or
the actuation joint 24 and/or the holding device 27 for the actuator 4 are/is held on the hand plate 10 by an adjusting device 77.

In the description of the figures, the same reference signs are sometimes used with regard to structural elements or components that correspond or are similar in terms of geometry and/or function, whereby these can then be distinguished from one another by the supplementary letter a, b . . . . These structural elements or components can then also be referred to without the supplementary letter, in which case one of the structural elements or components, several or all structural elements or components can be meant.

Many variations and modifications may be made to the preferred embodiments of the invention without departing substantially from the spirit and principles of the invention. All such modifications and variations are intended to be included herein within the scope of the present invention, as defined by the following claims.

I claim:

1. A finger orthosis for a finger exoskeleton with
a) an actuating member,
b) a second phalanx accommodation and
c) a third phalanx accommodation,
d) a constraining guide which couples the second phalanx accommodation to the third phalanx accommodation with a fixed dependency of
a relative first pivot angle between the actuating member and the second phalanx accommodation and
a relative second pivot angle between the second phalanx accommodation and the third phalanx accommodation, wherein
e) the second phalanx accommodation is pivotably linked to the actuating member in a first joint and is freely pivotable relative to the actuating member.

2. The finger orthosis according to claim 1, wherein to form the constraining guide
a) the second phalanx accommodation is connected to the third phalanx accommodation via a second joint and
b) a coupling rod is provided, which
ba) is articulated to the actuating member at a distance from the first joint in a first coupling rod joint, and
bb) is articulated to the third phalanx accommodation at a distance from the second joint in a second coupling rod joint.

3. The finger orthosis according to claim 1, wherein the finger orthosis comprises only one single actuating member.

4. The finger orthosis according to claim 1, wherein the second phalanx accommodation and the third phalanx accommodation are connected to each other exclusively via a second joint and one single coupling rod.

5. The finger orthosis according to claim 3, wherein the second phalanx accommodation and the third phalanx accommodation are connected to each other exclusively via a second joint and one single coupling rod.

6. The finger orthosis according to claim 1, wherein a holding device for an actuator is provided and the actuating member is held pivotably on the holding device by an actuation joint and the holding device comprises a compensating device which provides at least one of a longitudinal compensation, a transverse compensation, a height compensation or an angular compensation.

7. The finger orthosis according to claim 2, wherein the finger orthosis is dimensioned in such a way that
a)—coordinates (x_{P,24}, y_{P,24}) of an actuation joint which pivotably holds the actuating member on a holding device for an actuator are dimensioned under consideration of a proximal scaling factor (PSKF) from first standard coordinates (x_{N,24}, y_{N,24}) and
a distance (A_{P,24-18}) between the actuation joint and the first joint is dimensioned under consideration of the proximal scaling factor (PSKF) from a first standard distance (A_{N,24-18});
b)—coordinates (x_{P,21}, y_{P,21}) of the first coupling rod joint are dimensioned under consideration of a distal scaling factor (DSKF) from second standard coordinates (x_{N,21}, y_{N,21}) and
a distance (A_{P,19-22}) of the second joint from the second coupling rod joint is dimensioned under consideration of the distal scaling factor (DSKF) from a third standard distance (A_{N,19-22}) and
a distance (A_{P,21-22}) of the first coupling rod joint from the second coupling rod joint is dimensioned under consideration of the distal scaling factor (DSKF) from a fourth standard distance (A_{N,21-22}),
or the distances (A_{P}) and coordinates (x_{P}, y_{P}) deviate by a maximum of +/−20% from these distances (A_{P}) and coordinates (x_{P}, y_{P}).

8. The finger orthosis according to claim 1, wherein the finger orthosis comprises a mechanical overload protection.

9. The finger orthosis according to claim 8, characterized in that the overload protection comprises a joint body and two joint body accommodations wherein the joint body is rotatably caught between the two joint body accommodations, the overload protection being provided in that an elastic or plastic deformation of at least one of the joint body accommodations, of a connecting region of the joint body accommodations or of the joint body takes place as a result of an overload in such a way that the joint body can exit from the joint body accommodations.

10. The finger orthosis according to claim 9, wherein the joint body comprises a partially spherical joint head and the joint body accommodations are joint sockets between which the partially spherical joint head is captured and mounted.

11. The finger orthosis according to claim 1, wherein the finger orthosis comprises a holding device for an actuator and an actuation joint which pivotably holds the actuating member on the holding device and which comprises a degree of freedom for an abduction and an adduction about an abduction and adduction pivot axis.

12. The finger orthosis according to claim 1, wherein the finger orthosis comprises a hand plate, a holding device for an actuator and an actuation joint which pivotably holds the actuating member on the holding device, wherein at least one of the actuation joint or the holding device is held on the hand plate by an adjusting device.

13. The finger orthosis according to claim 12, wherein the adjusting device comprises a spindle drive.

14. A finger exoskeleton comprising
a) a finger orthosis with
an actuating member,
a second phalanx accommodation and
a third phalanx accommodation,
wherein the second phalanx accommodation is coupled to the third phalanx accommodation via a constraining guide in such a way that a fixed dependency
of a relative first pivot angle between the actuating member and the second phalanx accommodation and
a relative second pivot angle between the second phalanx accommodation and the third phalanx accommodation
is given, wherein
the second phalanx accommodation is pivotably linked to the actuating member in a first joint and is freely pivotable relative to the actuating member
b) and an actuator coupled to the finger orthosis for actuation.

15. A method of manufacturing a finger orthosis with
an actuating member,
a second phalanx accommodation and
a third phalanx accommodation,
a holding device for an actuator and
an actuation joint which pivotably holds the actuating member the holding device
wherein the second phalanx accommodation is coupled to the third phalanx accommodation via a constraining guide in such a way that a fixed dependency of
a relative first pivot angle between the actuating member and the second phalanx accommodation and
a relative second pivot angle between the second phalanx accommodation and the third phalanx accommodation
is given, wherein
the second phalanx accommodation is pivotably linked to the actuating member in a first joint and is freely pivotable relative to the actuating member and
to form the constraining guide the second phalanx accommodation is connected to the third phalanx accommodation via a second joint and a coupling rod is provided, which is articulated to the actuating member at a distance from the first joint in a first coupling rod joint and is articulated to the third phalanx accommodation at a distance from the second joint in a second coupling rod joint,
the method comprising the following method steps:
a) determining a proximal scaling factor (PSKF) based on the length (L₅₂) of a first phalanx (52) and determining a distal scaling factor (DSKF) based on the length (L₅₃) of a second phalanx (53);
b) determining
the coordinates (x_{P,24}, y_{P,24}) of the actuation joint by converting first standard coordinates (x_{N,24}, y_{N,24}) under consideration of the proximal scaling factor (PSKF)
the distance (A_{P,24-18}) between the actuation joint and the first joint by converting a first standard distance (A_{N,24-18}) under consideration of the proximal scaling factor (PSKF) and
the distance (A_{P,56-18}) between a PIP body joint and the first joint by converting a second standard distance (A_{N,56-18}) under consideration of the proximal scaling factor (PSKF);
c) determining
the coordinates (x_{P,21}, y_{P,21}) of the first coupling rod joint by converting second standard coordinates (x_{N,21}, y_{N,21}) under consideration of the distal scaling factor (DSKF),
the distance (A_{P,19-22}) of the second joint from the second coupling rod joint by converting a third standard distance (A_{N,19-22}) under consideration of the distal scaling factor (DSKF) and
the distance (A_{P,21-22}) of the first coupling rod joint from the second coupling rod joint by converting a fourth standard distance (A_{N,21-22}) under consideration of the distal scaling factor (DSKF),
or determining the distances (A_{P}) and coordinates (x_{P}, y_{P}) with a maximum deviation of +/−20% from the above given distances (A_{P}) and coordinates (x_{P}, y_{P}).

16. The method according to claim 15, wherein at least one of the proximal scaling factor (PSKF) or the distal scaling factor (DSKF) is determined by means of an automatic image processing or a 3D scan.

17. The method according to claim 16, wherein a 3D model of members of the finger orthosis is created on the basis of the determined dimensions and the members are manufactured by means of an additive manufacturing process.

18. The method according to claim 15, wherein a further finger orthosis for a different finger with only a first phalanx of the different finger moved by the further finger orthosis and a second phalanx of the different finger moved by the further finger orthosis and with a second phalanx accommodation without a third phalanx accommodation articulated thereto is produced by use of the following method steps:
a) determining a proximal scaling factor (PSKF) of the further finger orthosis based on the length (L₂₂) of the first phalanx of the different finger; and
b) determining
the coordinates (x_{P,24}, y_{P,24}) of the actuation joint of the further finger orthosis by converting first standard coordinates (x_{N,24}, y_{N,24}) under consideration of the proximal scaling factor (PSKF),
the distance (A_{P,24-18}) between the actuation joint of the further finger orthosis and the first joint of the further finger orthosis by converting a first standard distance (A_{N,24-18}) under consideration of the proximal scaling factor (PSKF), and
the distance (A_{P,56-18}) between the PIP body joint of the further finger and the first joint of the further finger orthosis by converting a second standard distance (A_{N,56-18}) under consideration of the proximal scaling factor (PSKF);
whereby deviations of theses distances (A_{P}) and coordinates (x_{P}, y_{P}) of +/−20% are also possible.
